(19) United States
(12) Patent Application Publication
(10) Pub. No.: US 2026/0368102 A1
(43) Pub. Date: Nov. 19, 2026

(54) INFORMATION PROCESSING DEVICE, CONTROL METHOD FOR INFORMATION PROCESSING DEVICE, AND NON-TRANSITORY COMPUTER-READABLE MEDIUM ON WHICH PROGRAM IS STORED

(71) Applicant: NEC Corporation, Tokyo (JP)

(72) Inventors: Jun FURUKAWA, Tokyo (JP); Takuya HAYASHI, Tokyo (JP); Satsuya OHATA, Tokyo (JP)

(73) Assignee: NEC Corporation, Tokyo (JP)

(21) Appl. No.: 19/145,958

(22) PCT Filed: Mar. 14, 2023
(86) PCT No.: PCT/JP2023/009826

§ 371 Date: Jul. 7, 2025

(51) Int. Cl. G06F 12/1081; G06F 9/455

(52) U.S. Cl. CPC G06F 12/1081; G06F 9/45558; G06F 2009/45583

(57) ABSTRACT

This information processing device comprises: memory having a data storage area to which a machine physical address is assigned; a cache having a data storage area to which a guest physical address is assigned; an authenticated encryption engine for performing encryption processing and authentication processing on data to be transferred between the cache and the memory; a first address conversion means that is managed by a guest and converts an external address indicating access to data to be subjected to the encryption processing and the authentication processing into the guest physical address; and a second address conversion means that is managed by a hypervisor and converts the guest physical address into a machine physical address corresponding to the guest physical address.

### TECHNICAL FIELD

The present disclosure relates to an information processing device, a control method for an information processing device, and a non-transitory computer-readable medium on which a program is stored.

### BACKGROUND ART

In recent years, it has been required to improve confidentiality and safety against an attack on a virtual machine from a hypervisor. A related technique is disclosed in, for example, PTL 1.

### CITATION LIST

### Patent Literature

PTL 1: JP 2013-205972 A

### Non Patent Literature

NPL 1: Meysam Taassori, Ali Shafiee, and Rajeev Balasubramonian. VAULT: reducing paging overheads in SGX with efficient integrity verification structures. In Xipeng Shen, James Tuck, Ricardo Bianchini, and Vivek Sarkar, editors, Proceedings of the Twenty-Third International Conference on Architectural Support for Programming Languages and Operating Systems, ASPLOS 2018, Williamsburg, VA, USA, March 24-28, 2018, pages 665-678. ACM, 2018.

### SUMMARY OF INVENTION

### Technical Problem

However, PTL 1 merely describes that a virtual address recognized by a guest is translated into a physical address recognized by a host, and still has a problem that a virtual machine cannot be protected from an attack of a hypervisor.

The present disclosure has been made to solve such a problem, and an object thereof is to provide an information processing device, a control method for an information processing device, and a non-transitory computer-readable medium on which a program is stored, which are capable of improving confidentiality and safety against an attack on a virtual machine from a hypervisor.

### Solution to Problem

An information processing device according to the present disclosure includes: a memory having a data storage area to which a machine physical address is assigned; a cache having a data storage area to which a guest physical address is assigned; an authenticated encryption engine performing encryption processing and authentication processing on data to be transferred between the cache and the memory; a first address translation means for translating an external address indicating access to data to be subjected to the encryption processing and the authentication processing into the guest physical address, the first address translation means being managed by a guest; and a second address translation means for translating the guest physical address into a machine physical address associated to the guest physical address, the second address translation means being managed by a hypervisor.

A control method for an information processing device according to the present disclosure is a control method for an information processing device that includes: a memory having a data storage area to which a machine physical address is assigned; a cache having a data storage area to which a guest physical address is assigned; an authenticated encryption engine performing encryption processing and authentication processing on data to be transferred between the cache and the memory; a first address translation means managed by a guest; and a second address translation means managed by a hypervisor. The control method including: translating an external address indicating access to data to be subjected to the encryption processing and the authentication processing into a guest physical address using the first address translation means in a case of accessing the cache; and translating the guest physical address into a machine physical address associated to the guest physical address using the second address translation means in a case of accessing the memory.

A non-transitory computer-readable medium according to the present disclosure is a non-transitory computer-readable medium on which a control program is stored, the control program causing a computer to execute control processing in an information processing device that includes: a memory having a data storage area to which a machine physical address is assigned; a cache having a data storage area to which a guest physical address is assigned; an authenticated encryption engine performing encryption processing and authentication processing on data to be transferred between the cache and the memory; a first address translation means managed by a guest; and a second address translation means managed by a hypervisor. The control program causes the computer to execute the control processing including: processing of translating an external address indicating access to data to be subjected to the encryption processing and the authentication processing into a guest physical address using the first address translation means in a case of accessing the cache; and processing of translating the guest physical address into a machine physical address associated to the guest physical address using the second address translation means in a case of accessing the memory.

### Advantageous Effects of Invention

According to the present disclosure, it is possible to provide the information processing device, the control method for the information processing device, and the non-transitory computer-readable medium on which the program is stored, which are capable of improving the confidentiality and the safety against the attack on the virtual machine from the hypervisor.

### BRIEF DESCRIPTION OF DRAWINGS

FIG. 1 is a block diagram illustrating a configuration example of an information processing device according to a first example embodiment.

FIG. 2 is a diagram schematically illustrating an information processing device according to a second example embodiment.

FIG. 3 is a conceptual diagram illustrating an access control structure achieved in the information processing device according to the second example embodiment.

FIG. 4 is a diagram illustrating address flows of a machine.

FIG. 5 is a diagram illustrating data flows in a case where a value of a register of a virtual machine is saved.

FIG. 6 is a diagram illustrating data flows in a case where a value of the register of the virtual machine is restored.

FIG. 7 is a diagram illustrating flows of address translation processing by the virtual machine.

FIG. 8 is a diagram illustrating flows of address translation processing by a hypervisor.

FIG. 9 is a conceptual diagram of an authentication tree.

FIG. 10 is a diagram illustrating a relationship between each of nodes constituting the authentication tree and a cache line associated thereto.

FIG. 11 is a diagram illustrating flows of data, keys, and the authentication tree at the time of data reading by a guest.

FIG. 12 is a diagram illustrating flows of data, keys, and the authentication tree at the time of data write-back by the guest.

FIG. 13 is a diagram illustrating flows of key installation.

### EXAMPLE EMBODIMENT

Hereinafter, example embodiments will be described with reference to the drawings. In the example embodiments, the same or equivalent elements are denoted by the same reference numerals, and repeated description will be omitted.

### First Example Embodiment

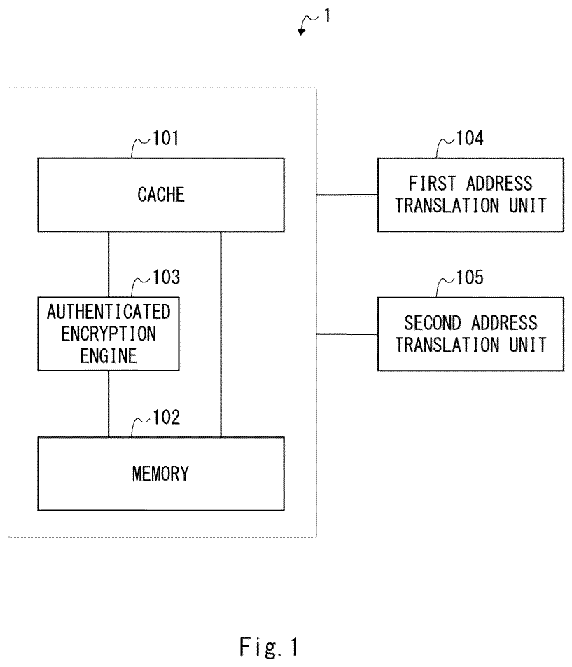

FIG. 1 is a block diagram illustrating a configuration example of an information processing device 1 according to a first example embodiment.

As illustrated in FIG. 1, the information processing device 1 includes a cache 101, a memory 102, an authenticated encryption engine 103, a first address translation unit 104, and a second address translation unit.

The cache 101 has a data storage area to which a guest physical address is assigned. The guest physical address is an address that is individually assigned to each guest (virtual machine) and designates a data storage area of the cache 101. That is, the cache 101 is configured to be capable of accessing data in the storage area designated by the guest physical address. In the cache 101, plaintext data is stored.

The memory 102 has a data storage area to which a machine physical address is assigned. The machine physical address is an address actually assigned to a data storage area of the memory 102. That is, the memory 102 is configured to be capable of accessing data in the storage area designated by the machine physical address. The memory 102 stores encrypted data (ciphertexts).

The authenticated encryption engine 103 performs encryption processing and authentication processing on data to be transferred between the cache 101 and the memory 102. For example, plaintext data read from the cache is subjected to encryption processing and authentication processing, and then written into the memory. The encrypted data read from the memory is subjected to decryption processing and authentication processing, and then stored in the cache.

Hereinafter, the encryption processing and the authentication processing (including the decryption processing and the authentication processing) by the authenticated encryption engine 103 are also referred to as authenticated encryption processing.

The authenticated encryption engine 103 preferably performs authentication processing using an authentication tree including a plurality of nodes connected in a tree shape, each of the nodes being assigned with a pair of a counter and an identifier. In the authentication processing using the authentication tree, not only authentication on data but also authentication on an authenticator is performed, so that the risk of data leakage is further reduced.

The first address translation unit (first address translation means) 104 is managed by a guest (virtual machine), and translates an externally supplied address (external address) indicating access to data to be subjected to authenticated encryption processing into a guest physical address. Here, since the guest physical address managed by the guest is assigned to the data storage area of the cache 101, a hypervisor cannot tamper with an access destination to the cache 101. That is, the information processing device 1 can prevent an attack on the cache 101 from the hypervisor. The hypervisor is software that creates and executes a guest (virtual machine).

The first address translation unit 104 may be configured to translate the external address based on identification information vmid of a designated virtual machine into a guest physical address, in addition to the address supplied from the outside. This enables access to the cache 101 belonging to the designated virtual machine among a plurality of virtual machines.

The second address translation unit (second address translation means) 105 is managed by the hypervisor and translates a guest physical address into a machine physical address. That is, in a case where data read from the cache 101 is subjected to authenticated encryption processing and then written back to the memory 102, a guest physical address is translated into a machine physical address associated to the guest physical address.

As described above, the information processing device 1 according to the present example embodiment can prevent the attack on the cache 101 from the hypervisor by configuring the cache 101 to enable access to the data storage area designated by the guest physical address managed by the guest. That is, the information processing device 1 according to the present example embodiment can improve confidentiality and safety against the attack on the virtual machine from the hypervisor.

The cache 101 may further include a data storage area to which a machine physical address is assigned, in addition to the data storage area to which the guest physical address is assigned. The data storage area to which the machine physical address is assigned out of the data storage areas of the cache 101, for example, stores data not to be subjected to authenticated encryption processing, and enables access from not only the guest but also the hypervisor. In this case, the first address translation unit 104 translates an externally supplied address indicating access to data to be subjected to authenticated encryption processing into a guest physical address, and translates an externally supplied address indicating access to the data not to be subjected to authenticated encryption processing into a machine physical address.

During a context switch, a value of a register of each virtual machine is preferably stored in a storage area designated by a guest physical address assigned to the virtual machine. This enables the register of the virtual machine to be stored using a key of the virtual machine. Thus, for example, at the time of migration, transfer from one virtual machine to another virtual machine can be performed without requiring processing that involves special protection such as re-encryption processing for exchanging encryption keys or access control by higher authority.

### Second Example Embodiment

In a second example embodiment, the information processing device 1 will be described in more detail.

### Security Model of Machine

In the present example embodiment, it is assumed that physical attacks on elements of a central processing unit (CPU), a memory management unit (MMU), an input-output memory management unit (IOMMU), a cache, a translation lookaside buffer (TLB), and an input-output translation lookaside buffer (IOTLB) provided in a processor in the information processing device 1 are not considered. That is, in the present example embodiment, it is assumed that the elements of the CPU, the MMU, the IOMMU, the cache, the TLB, and the IOTLB provided in the processor are securely mounted to an extent that it is not necessary to consider any attack. In the present example embodiment, it is also assumed that safety is secured for communication between a plurality of the elements provided in the processor to such an extent that it is not necessary to consider any attack.

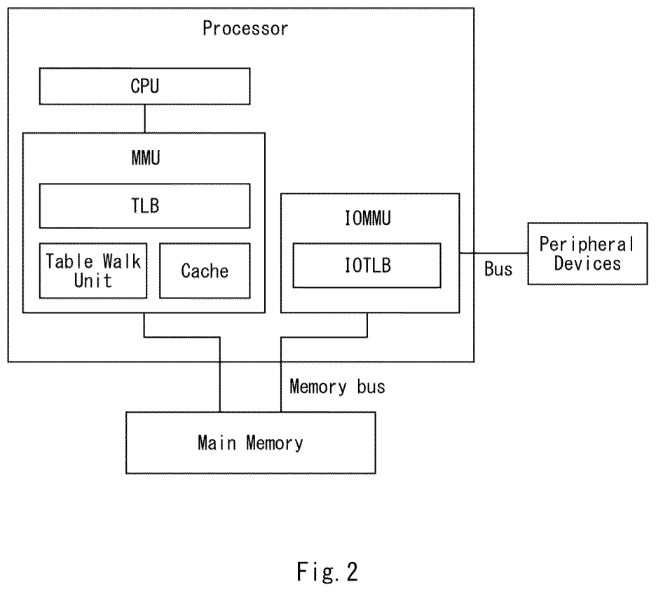

On the other hand, it is assumed that a memory bus and a memory are likely to be attacked by eavesdropping, tampering, and the like. This represents that a physical attack on the inside of the processor is difficult, but a physical attack on the outside of the processor is not necessarily difficult when referring to a schematic diagram of FIG. 2.

In the present example embodiment, it is assumed that three types of authority of a machine, a hypervisor, and a guest are implemented in the CPU. The guest is assumed to be a virtual machine. The guest authority is assumed to be a supervisor authority (guest supervisor authority) of the virtual machine.

A guest user (a user of the virtual machine) is given a virtual address from a guest supervisor. This virtual address is translated into a guest physical address according to contents of translation designated by the guest supervisor, and this guest physical address is translated into a machine physical address according to contents of translation designated by the hypervisor. It is assumed that attackers are all or some of the hypervisor, a non-target guest, and a physical attacker. It is assumed that the machine authority can withstand an attack from the hypervisor authority. However, a mechanism in which the machine authority withstands the attack from the hypervisor authority needs to be separately implemented. For example, in order to make the memory available in a machine mode, a method for protecting the memory from the hypervisor needs to be separately implemented.

When the permission to use a memory space accessible is given to the guest authority by the authority of the hypervisor or higher, calculation resources can be used in the given memory space without being interfered by the authority of the hypervisor or the machine until such authority is removed by an exception or an interrupt. However, as described above, it cannot be excluded that the given memory space is physically attacked. In a case where a certain guest has authority, a register, the cache, the TLB, and the like are not accessible by the hypervisor and another guest, but these are not prevented from being accessed by another authority when the guest returns the authority.

### Access Control Using Authenticated Encryption Processing

The virtual machine of the guest is identified by the identification information vmid. In a case where the authority is in a guest mode, that is, in a case where it is assumed that a certain virtual machine is running, identification information vmid of the running virtual machine is designated in the MMU. As a result, data accessible by the running virtual machine is limited only to data related to the identification information vmid designated in the MMU.

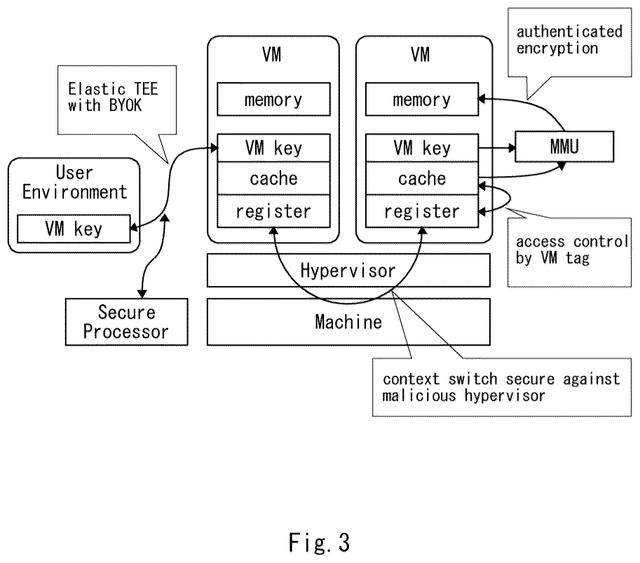

FIG. 3 is a conceptual diagram illustrating an access control structure achieved in the information processing device 1. As illustrated in FIG. 3, access control by the designated scheme can be performed in the information processing device 1 by applying a designated access control scheme to each of a hierarchical storage area including a register, a cache, and a memory provided in each virtual machine (VM), and the register during a context switch.

Here, there is a possibility that the register of each virtual machine is operated by the hypervisor during the context switch if no measure is taken. However, the register is protected directly by hardware or by saving a register value in advance in a machine mode.

There is a possibility that the cache of each virtual machine is operated by the register of another virtual machine if no measure is taken. However, first, a cache line in the cache of each virtual machine is tagged with identification information vmid of the related virtual machine. The register of each virtual machine is configured to be capable of accessing only a cache line tagged with the same identification information vmid as that of the related virtual machine. As a result, the cache of each virtual machine is protected.

Further, the memory of each virtual machine is likely to be attacked at the time of data transfer with the cache if no measure is taken. However, in each virtual machine, data in the memory is protected by performing authenticated encryption processing on the data transferred between the cache and the memory. The authenticated encryption processing can also prevent a physical attack on the memory. A key used for the authenticated encryption processing limits access by the hypervisor.

Hereinafter, access control of the register, access control of the cache, and access control of the memory will be specifically described.

### Access Control of Register

In the context switch, the hypervisor having execution authority temporarily stops execution of processing and hands the execution authority over to the guest (virtual machine), or the guest (virtual machine) having the execution authority interrupts execution of processing and returns the execution authority to the hypervisor.

For example, in a case where the hypervisor hands the execution authority over to the guest, first, the hypervisor sends identification information vmid of a virtual machine to be executed to the machine, and then returns the execution authority to the machine. Thereafter, the machine passes the identification information vmid received from the hypervisor to the MMU. In order to start execution of the virtual machine of the identification information vmid received from the hypervisor, the machine restores a value of a register saved in a memory area of the virtual machine. Thereafter, the machine hands the execution authority over to the guest. The machine cannot pass the identification information vmid to the MMU unless the execution authority is handed over to the guest.

In addition, in a case where the guest (virtual machine) returns the execution authority to the hypervisor, first, the guest having the execution authority causes a value of a register of a virtual machine whose execution has been interrupted to be saved in a memory area of the virtual machine. Thereafter, the guest having the execution authority instructs the MMU to invalidate the previously passed identification information vmid. Thereafter, the guest returns the execution authority to the hypervisor. However, even in a case where the execution of the virtual machine is interrupted, when it is sufficient to give the execution authority to a supervisor of the same virtual machine without returning to the hypervisor, the guest hands the execution authority over to the relevant guest supervisor without saving the value of the register.

Here, in a case where the machine saves a value of a register of a virtual machine in a memory area of the virtual machine or restores the value of the register saved in the memory area of the virtual machine, a code of the machine needs to access the memory area of the virtual machine. In this access, a guest physical address is used. Specifically, the machine accesses the memory through the cache by using an address of the machine regarding an instruction, and accesses the memory through the cache by using the address of the virtual machine for data.

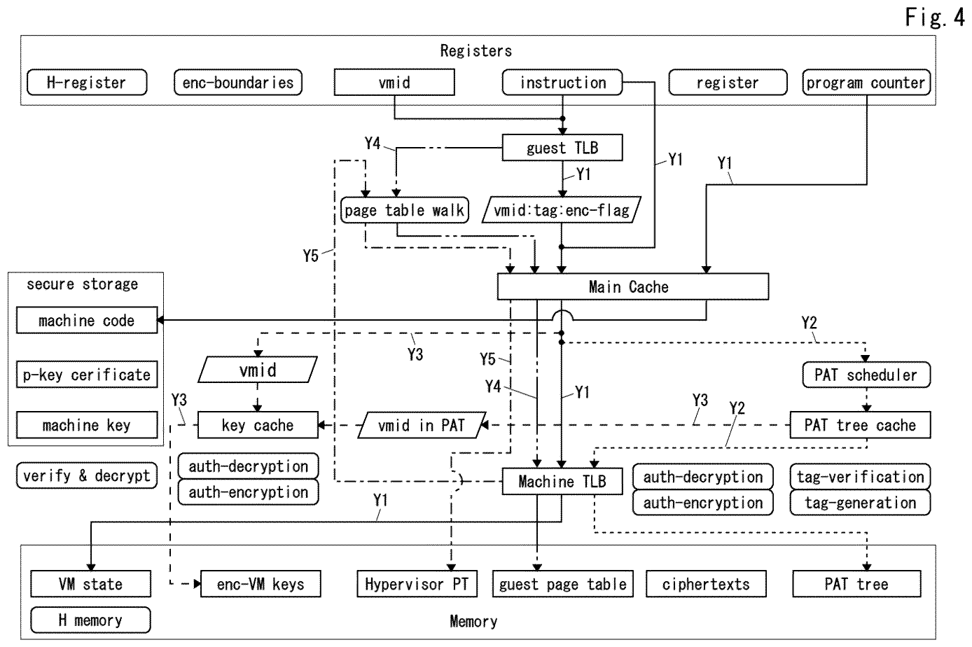

FIG. 4 is a diagram illustrating address flows of the machine. A page table, address translation by a page table walk, and a TLB will be described later.

In FIG. 4, a main cache corresponds to the cache 101 in FIG. 1. A guest TLB corresponds to the first address translation unit 104 in FIG. 1. A machine TLB corresponds to the second address translation unit 105 in FIG. 1. A memory corresponds to the memory 102 in FIG. 1. Auth-encryption, auth-decryption, tag-verification, and tag-generation correspond to the authenticated encryption engine 103 in FIG. 1.

As authenticated encryption processing is performed on data, an authenticator is generated in addition to a ciphertext. An element of the authenticator is represented as PAT in FIG. 4. The data to be protected is translated into the ciphertext and the authenticator by the authenticated encryption processing and stored in the memory. However, the authenticator may be stored in a cache of the PAT. In a case where the ciphertext stored in the memory is read, the authenticator associated to the ciphertext is also read, and the read ciphertext and authenticator are used to decrypt and verify the ciphertext. This verification makes it possible to confirm whether the ciphertext has not been tampered with or replaced.

In general, the authenticator used to verify the presence or absence of tampering and replacement of the ciphertext has a dependency relationship with an authenticator of other data. With this dependency relationship, it is possible to determine which data among pieces of data stored in the memory has been tampered with even in a case where tampering such as returning part of the data of the memory to past data has been performed. In authenticated encryption processing in which a plurality of authenticators have dependency relationships, it is necessary to adjust the order of processing of the plurality of authenticators. A PAT scheduler in FIG. 4 adjusts the order of processing of the plurality of authenticators.

FIG. 4 illustrates address flows in processing of saving a value of a register of a virtual machine in a case where execution of the virtual machine is interrupted, and processing of returning the saved value of the register to the register of the virtual machine in a case where the execution of the virtual machine is resumed. A program counter in FIG. 4 indicates an address of a code for saving the value of the register. This address is an address of the code of the machine authority and exists in an address space of the machine. Therefore, this address is read into the main cache without passing through the guest TLB and without being subjected to address translation. This address is stored in a safe area before being read into the main cache. Although the code of the address indicated by the program counter is the code for saving the value of the register, the program counter indicates an address of a VM state as an address of a saving destination of the value of the register. This address is an address of the guest, and thus is translated into an address of the machine by the guest TLB and the machine TLB. Since the address translation in the virtual machine is performed in the guest TLB, some data does not pass through the guest TLB. These address flows are represented by Y1.

In a case where the value of the register is to be saved in the VM state, the authenticated encryption engine reads a key designated by an identifier vmid of the virtual machine from a key cache, and performs authenticated encryption processing on the value of the register to be saved using the key. In a case where the required key is not written in the key cache, the authenticated encryption engine reads and decrypts an encrypted key stored in enc-VM keys of the memory and uses the decrypted key. These address flows are represented by Y3.

In the authenticated encryption processing, generation and verification of an authenticator are performed in addition to encryption or decryption of data. A storage area of the memory in which the authenticator is stored is designated by an address. This address flow is represented by Y2.

The guest TLB translates a virtual address in the virtual machine into a physical address of the virtual machine using the page table walk. A table of this translations is stored in the memory of the (real) machine. The address of the machine is assigned to a storage area of the memory of the machine in which the translation table is stored. However, in the virtual machine, since the address of the virtual machine is apparently assigned to the storage area of the memory of the machine, the address designated in the virtual machine needs to be translated into the address of the machine by the machine TLB. This address flow is represented by Y4.

The machine TLB translates the address of the virtual machine into the address of the (real) machine using the page table walk. A table of this translation is stored in the memory of the machine. Therefore, the storage area of the memory of the machine in which the translation table is stored is designated by the address of the machine. This address flow is represented by Y5.

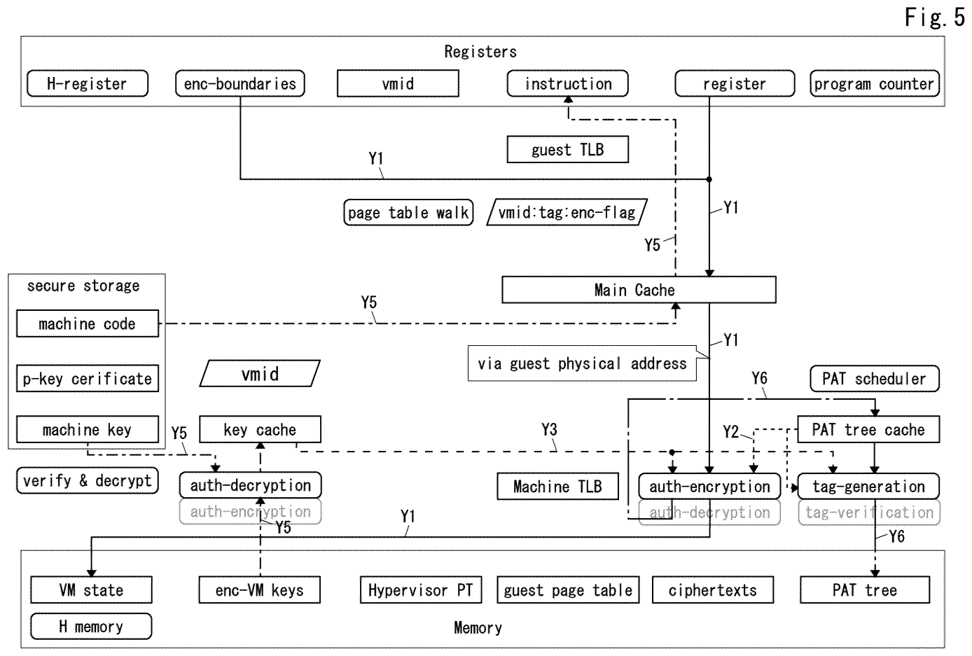

FIG. 5 is a diagram illustrating a data flow in a case where a value of the register of the virtual machine is saved. Y1 represents a flow of saving of a value of each of the register and an enc-boundaries register indicating an application range of authenticated encryption processing. When data read from the main cache is written into the memory, the authenticated encryption processing is performed on the data by the auth-encryption.

In the authenticated encryption processing, generation of an authenticator is performed in addition to encryption or decryption of data. A flow of generation of the authenticator, storage of the authenticator in the PAT cache, and processing of storing another authenticator related to the authenticator in the memory is represented by Y6. Although the other authenticator is used to generate this authenticator, flows of processing of acquiring the other authenticator from the PAT cache are represented by Y2.

Flows of processing of reading a key used in the authenticated encryption processing from the key cache are represented by Y3. In a case where the required key is not written in the key cache, an encrypted key stored in the enc-VM keys of the memory is read, decrypted using a machine key, and then stored in the key cache. Flows of this processing are represented by Y5.

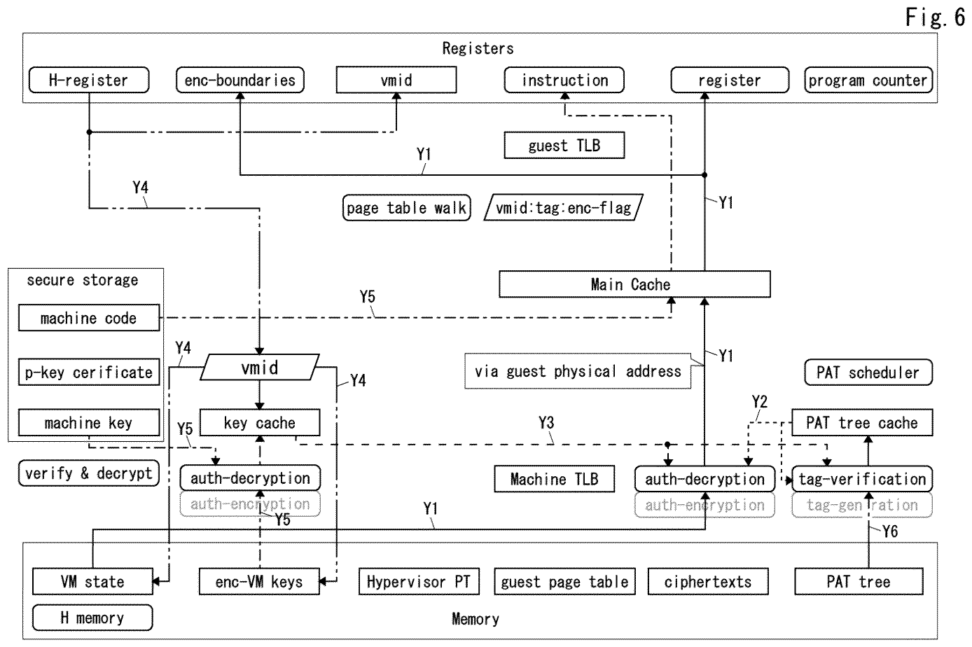

FIG. 6 is a diagram illustrating a data flow in a case where a value of the register of the virtual machine is restored. Y1 represents a flow of restoration of a value of each of the register and the enc-boundaries register indicating the application range of authenticated encryption processing. When data read from the memory is written into the main cache, the authenticated encryption processing is performed on the data by the auth-decryption. As a result, the data is decoded, verified, and then restored.

In the verification at the time of decryption of the data in the authenticated encryption processing, processing in which an authenticator of the data and another authenticator related thereto are read from the memory, decrypted, verified, and then written into the main cache is performed. A flow of this processing is represented by Y6. In addition, processing in which the authenticator of the data to be restored is used for the verification at the time of decryption of the data in the authenticated encryption processing is represented by Y2.

Flows of processing of reading a key used in the authenticated encryption processing from the key cache are represented by Y3. In a case where the required key is not written in the key cache, an encrypted key stored in the enc-VM keys of the memory is read, decrypted using a machine key, and then stored in the key cache. Flows of this processing are represented by Y5. This key is generated and registered by a user of the virtual machine outside a cloud. Specifically, the key generated outside the cloud is encrypted using a public key of the machine, passes through a hypervisor (hypervisor register) of the cloud, is decrypted using the key of the machine, and then is registered. Flows of this processing are represented by Y4.

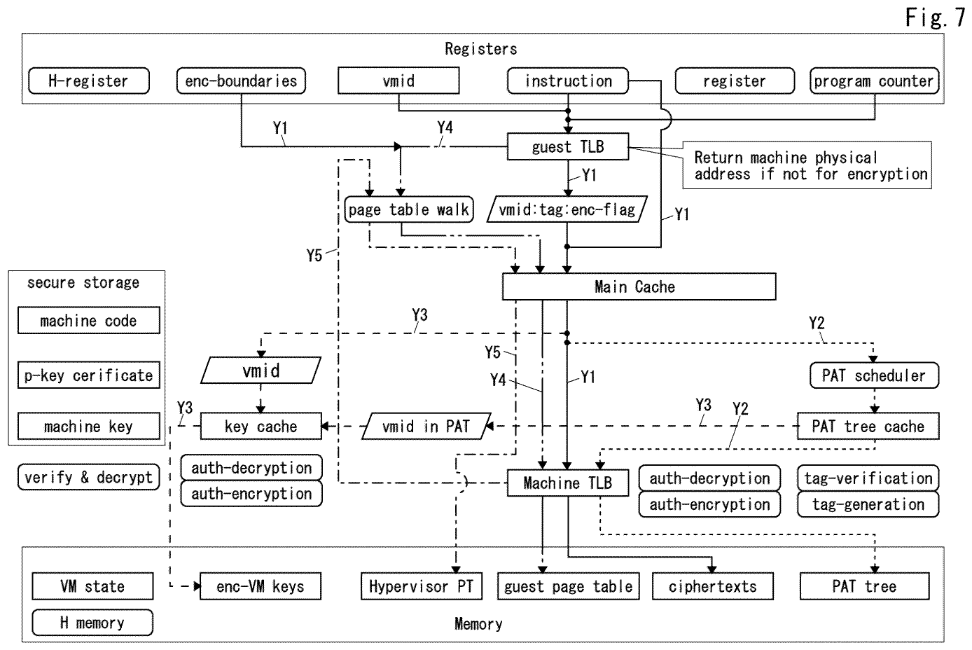

FIG. 7 is a diagram illustrating flows of address translation processing by the virtual machine. In a case where the virtual machine executes its own code, the program counter indicates an address of the virtual machine as an address of the code. This address is either a virtual address of the virtual machine or a real address of the virtual machine. Here, the virtual address of the virtual machine is translated into the real address of the virtual machine in the guest TLB. On the other hand, the real address of the virtual machine is used for accessing the main cache without being subjected to address translation in the guest TLB. However, an address of data that is not protected by authenticated encryption processing among pieces of data accessed by the virtual machine is translated up to an address of the machine. In accessing the memory from the main cache, the address of the virtual machine is translated into the address of the machine in the machine TLB. These address flows are represented by Y1.

For data that is protected by the authenticated encryption processing among the pieces of data accessed by the virtual machine, an address of an authenticator associated to the data is obtained by an address of the data. The address of the authenticator is the real address of the virtual machine, and the necessary authenticator is extracted from a storage area of the PAT cache designated by the address. If the authenticator is not cached in the PAT cache, the authenticator needs to be extracted from the memory. In this case, the address of the authenticator is translated into an address of the machine in the machine TLB and then used to access the memory. This address flow is represented by Y2.

A guest page table is referred to in the translation of the virtual address of the virtual machine in the address translation using the page table walk. A storage destination address of this table is represented by an address of the virtual machine at a level of the virtual machine. Therefore, in a case where the table is stored in the main cache, the storage destination address of the table is directly used to access the main cache. On the other hand, in a case where the table is stored in the memory, the storage destination address of the table is translated into an address of the machine in the machine TLB and then used to access the memory. This address flow is represented by Y4.

The machine TLB translates an address of the virtual machine into an address of the machine, and contents of the translation are recorded in a hypervisor page table (PT). Whether this page table is stored in the main cache or the memory, a storage destination address of the page table is represented by an address of the common machine. This address flow is represented by Y5.

A key used for the authenticated encryption processing of the virtual machine is read from a storage area of the key cache assigned by the identifier vmid of the virtual machine. In a case where the required key is not cached in the key cache, an encrypted key is read from the enc-VM keys of the memory, decrypted using a machine key, and then stored in the key cache. Flows of this processing are represented by Y3.

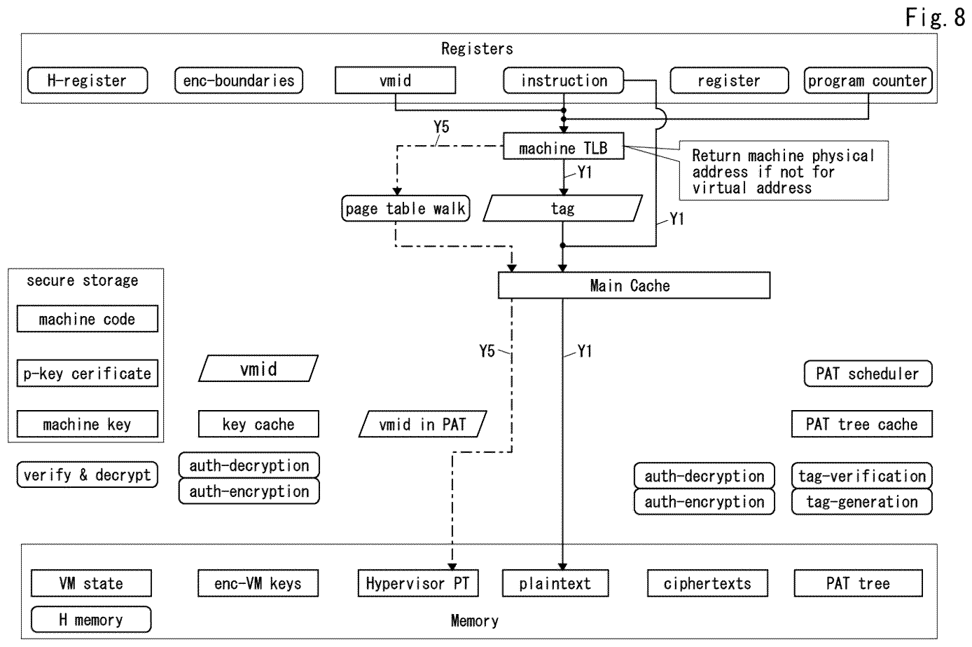

FIG. 8 is a diagram illustrating flows of address translation processing by the hypervisor. In a case where a virtual address is used in the hypervisor, the virtual address is translated into an address of the machine in the machine TLB. Since an address other than the virtual address in the hypervisor is an address of the machine, translation is unnecessary. These address flows are represented by Y1. The hypervisor page table (PT) is used to translate the virtual address. A location where this table is stored is represented by an address of the machine. This address flow is represented by Y5.

In the virtual machine, how a value of the register saved in the memory area designated by the guest physical address is protected from attacks of other guests and the hypervisor is determined based on access control similar to that in the cases of the cache and the memory to be described later. The guest does not have authority to access a register of the hypervisor. The hypervisor does not have authority to access a register of the machine.

### Access Control of Cache

In a case where identification information vmid of a certain virtual machine is designated in the MMU, the virtual machine running with the guest authority accesses data stored in the cache. At this time, the virtual machine designates an address of a cache line in the cache to the MMU by an instruction or an instruction pointer. This address is either a virtual address (an address given by the guest supervisor to a process of the guest) or a guest physical address (a virtual address given by the hypervisor to the guest supervisor). In the case of the virtual address, the MMU translates the virtual address into the guest physical address according to the contents of translation designated by the guest supervisor.

The virtual machine classifies guest physical addresses to be implemented into a guest physical address that prohibits access by others and a guest physical address that permits access by the hypervisor. The guest physical address that permits access of the hypervisor is used for IO or the like requested to the hypervisor. The guest classifies the guest physical addresses by designating a range using its unique register.

Specifically, the MMU tags the identification information vmid of the virtual machine with respect to the protected guest physical address, and translates the unprotected guest physical address into a machine physical address according to the contents of translation defined by the hypervisor. As a result, a cache line written from the register of the guest (virtual machine) to the cache and a cache line read from the cache of the guest to the register are identified by the guest physical address tagged with the identification information vmid of the guest or identified by the machine physical address not tagged with the identification information vmid.

The translation designated by the guest supervisor is translation designated by a guest page table. Here, the guest saves the guest page table in a memory area of a guest physical address that is not shared with others. The upper part of FIG. 7 illustrates flows of address translation from the register of the guest to the cache.

Next, in a case where the hypervisor accesses the cache, the hypervisor designates a virtual address or a machine physical address of a cache line in the cache with respect to the MMU. For example, when a virtual address is input, the MMU translates the virtual address into a machine physical address according to the contents of translation designated by the hypervisor.

At this time, the MMU does not tag identification information vmid of any guest with respect to the designated address. That is, vmid=0 is set. FIG. 8 illustrates flows of address translation of the hypervisor. As a result, the cache line written from the register of the hypervisor to the cache and the cache line read from the cache to the register of the hypervisor are identified by the machine physical address not tagged with the identification information vmid.

The machine accesses the cache by designating a machine physical address, but can access only the cache of the virtual machine of the identification information vmid designated in the MMU during the context switch. This is as illustrated in FIG. 4.

As a result of the above-described address translation, the access control for the cache is achieved as follows. A guest (virtual machine) to which certain identification information vmid is assigned can access a cache line tagged with the same identification information vmid by designating its own guest physical address.

This virtual machine can access the cache line designated by the guest physical address that is allowed to be shared with the hypervisor. This cache line is identified in the cache by a machine physical address, but which machine physical address is assigned to this cache line is determined by the hypervisor. That is, the virtual machine can access the cache line identified by the machine physical address assigned by the hypervisor.

Each virtual machine cannot access a cache line that is not allowed to be shared with the hypervisor by a guest (virtual machine) with another identification information vmid. The hypervisor can access the cache line allowed to be shared with the hypervisor, but cannot access any of cache lines assigned with the identification information vmid.

The machine can access cache lines of data assigned with the identification information vmid to be subjected to the context switch and the identification information vmid designated in the MMU. Since this cache line of the data of the guest accessible by the machine is merely used for saving a value of the register, a guest physical address used for designating the cache line may be limited to a small part.

### Access Control of Memory

As authenticated encryption processing is performed on data transferred between the cache and the memory, the access control at a level of the cache is extended to the access control of the memory. The authenticated encryption processing is performed by the MMU. By the authenticated encryption processing, dependency on the machine authority for protection of a guest memory can be greatly reduced.

A cache line tagged with identification information vmid of a certain guest cannot be accessed by the hypervisor and guests with pieces of other identification information vmid. However, in a case where this cache line is written in a storage area of a memory designated by a certain address, if no measure is taken, there is a possibility that the hypervisor attacks by designating the address using a machine physical address. Alternatively, there is a possibility that the hypervisor attacks by allocating the address as a guest physical address of another guest or allocating the address as another guest physical address of the same guest. These attacks can be prevented by the authenticated encryption processing.

The reason why the address of the cache line that prohibits the accesses of the hypervisor and other guests is a guest physical address is for guaranteeing the integrity with respect to the address only by authenticated encryption processing at the time of accessing the cache from the memory. When the address of the cache line that prohibits the accesses by the hypervisor and the other guests is the guest physical address, it is also necessary to guarantee correctness of translation from the guest physical address to a machine physical address in order to guarantee the integrity with respect to the guest physical address. Since the translation from the guest physical address to the machine physical address is performed by the hypervisor, a special mechanism is additionally required to guarantee the correctness of the translation.

In the present example embodiment, it is assumed that the MMU holds a plurality of sets of keys and root counters associated to a plurality of guests. Each of the guests performs the authenticated encryption processing using the associated key and root counter held in the MMU. How to prepare the key and the root counter used for the authenticated encryption processing will be described later.

For example, a cache line is read from the memory and written into the cache as needed. The cache line is read from the cache, and is written or written back to the memory.

When a cache line of an address tagged with certain identification information vmid is read from the memory and written into the cache, the MMU decrypts data read from the memory using a key and a root counter, associated with the identification information vmid, of the authenticated encryption processing and writes the decrypted data into the cache. The MMU associates the data written in the cache at this time with a guest physical address thereof, and then performs authentication processing for them.

When a cache line of an address tagged with certain identification information vmid is read from the cache and written into the memory, the MMU encrypts data read from the cache using a key and a root counter, associated with the identification information vmid, of the authenticated encryption processing and then writes the encrypted data into the memory. At this time, the MMU updates a value of a relevant counter, generates an authenticator in association with a guest physical address thereof, and writes the authenticator in the memory.

present example embodiment, data authentication is performed using an authentication tree including a plurality of nodes connected in a tree shape, each of the nodes being assigned with a pair of a counter and an identifier. In the data authentication using the authentication tree, not only authentication on data but also authentication on an authenticator is performed, so that the risk of data leakage is further reduced.

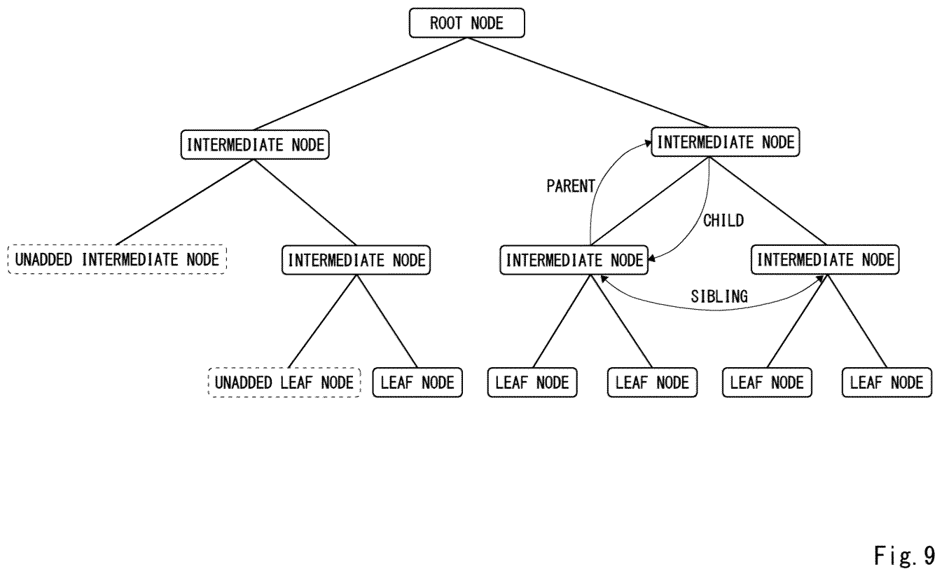

FIG. 9 is a conceptual diagram of the authentication tree. A counter and an identifier are assigned to each of nodes constituting the authentication tree. An identifier of each of leaf nodes (nodes at the lowest layer) matches a memory address of an associated cache line. An identifier of an intermediate node is derived based on a position in the tree. In addition, each of the leaf nodes is assigned with data associated to the memory address (identifier). That is, when being written into the cache 101, the data matches the cache line written into the cache 101.

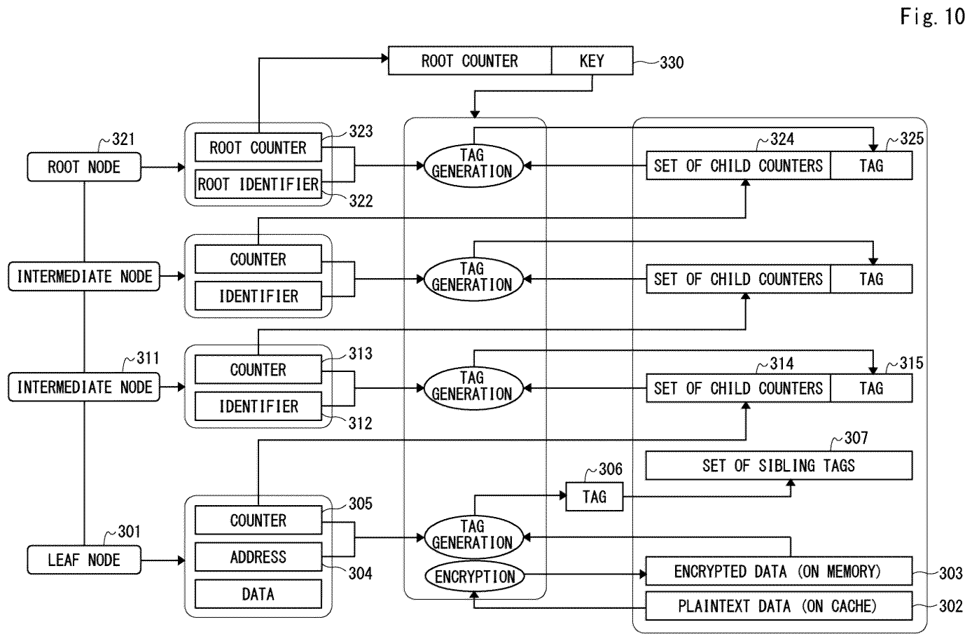

FIG. 10 is a diagram illustrating a relationship between each of nodes constituting the authentication tree and a cache line associated thereto. As illustrated in FIG. 10, in each of leaf nodes 301, encrypted data (hereinafter, also simply referred to as ciphertext) 303 is generated from plaintext data 302 stored in an associated cache line, and a tag (authenticator, MAC) 306 is generated by the ciphertext 303, a memory address 304, and a count value of a counter 305. The tag generated in each of the leaf nodes 301 is stored in another cache line 307 together with a tag generated in another node (sibling node) having a common intermediate node as a parent node.

In each of intermediate nodes 311, a tag 315 is generated by an assigned identifier 312 and a count value of an assigned counter 313, and a set 314 of count values of counters of child nodes. Similarly, in a root node (node at the highest layer) 321, a tag 325 is generated by an assigned identifier 322, a count value of an assigned counter 323, and a set 324 of count values of counters of child nodes.

Here, in a case where a count value of a counter indicates “0”, it represents that an address assigned to each of the node to which the counter is assigned and its descendant nodes is not used (reading of data of the address is not performed). As a result, the nodes not to be used are excluded from the authentication tree, so that an efficient operation is enabled even in a case where an address space is large but the amount of data to be used is small. A key 330 is also used for data encryption and tag generation.

In the present example embodiment, a case where each counter is of a split type will be described as an example. Details of the split-type counter are disclosed in, for example, NPL 1. The counter assigned to each node is a minor counter having a small area. In addition, a plurality of minor counters assigned to a plurality of child nodes (sibling nodes) of a common node share one major counter. This makes it possible to reduce the memory occupancy while enabling a large number of updates. For example, in a case where a count value of a certain minor counter exceeds the maximum value, a count value of a major counter thereof is counted up, and among minor counters assigned to the minor counter and sibling nodes thereof, count values of all minor counters having count values other than “0” are reset to “1”. As described above, the address assigned to each of the node to which the counter indicating the count value “0” is assigned and its descendant nodes is not used.

It is assumed that each split-type counter is static, and an area assigned to each minor counter is always the same area. In addition, it is assumed that a major counter is on the same cache line as its minor counters. In addition, it is assumed that appropriate size and structure of the authentication tree are determined from a size of an address space to be subjected to authenticated encryption and the number of branches of each layer of the authentication tree.

When a certain leaf node is updated, in principle, count values of all counters on a path from the leaf node to the root node are counted up. However, for some counters, the count-up of count values may be performed in a delayed manner, or the count-up of count values of a plurality of times may be collectively performed. The counter assigned to the root node is specially protected from being directly operated by an attacker. Then, a tag of the relevant node is updated by the counter of the root node, the counter of each intermediate node, or the counter of each leaf node and the data. As a result, tags of the nodes follow the latest state. Here, when a private key and the counter of the root node not to be tampered with are used, even if a ciphertext and/or a tag is tampered with or replaced with past data, these can be detected.

When data of a certain leaf node is updated, not only authentication is performed on data of this leaf node, but also authentication is performed on tags (authenticators) of nodes existing on a path from the leaf node to the root node, so that the risk of data leakage is further reduced.

A machine physical address designated in the memory at the time of access to the memory is obtained by address translation processing by the hypervisor. Whether the address translation processing by the hypervisor is correctly performed depends on whether the hypervisor behaves correctly. For example, whether the address translation processing by the hypervisor is correctly performed depends on whether the hypervisor is an attacker. A guest having identification information vmid assigned to a cache line to be written into the memory does not necessarily have authority at the time when the cache line is written into the memory.

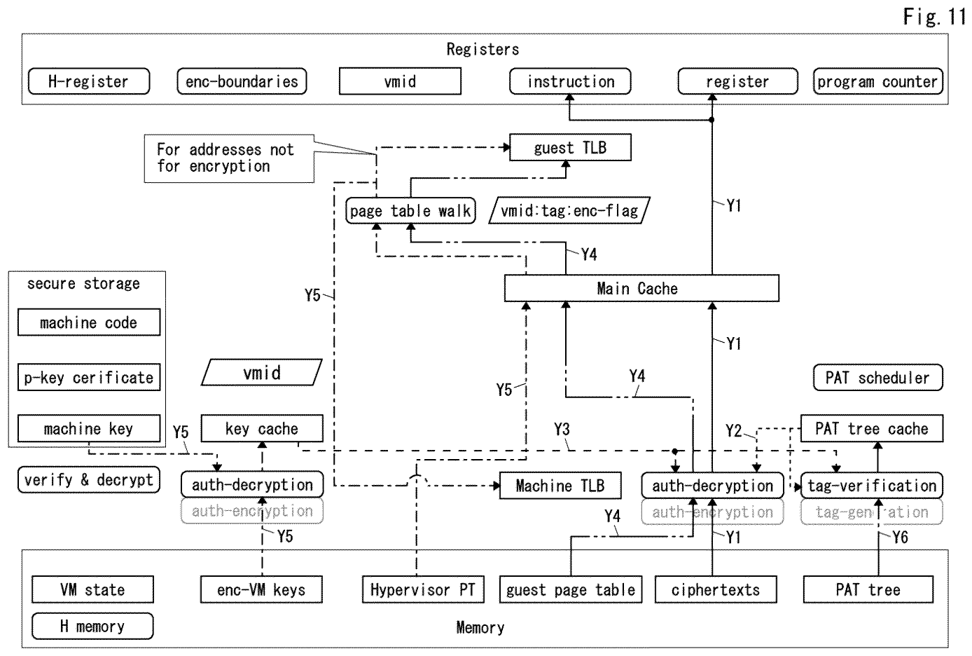

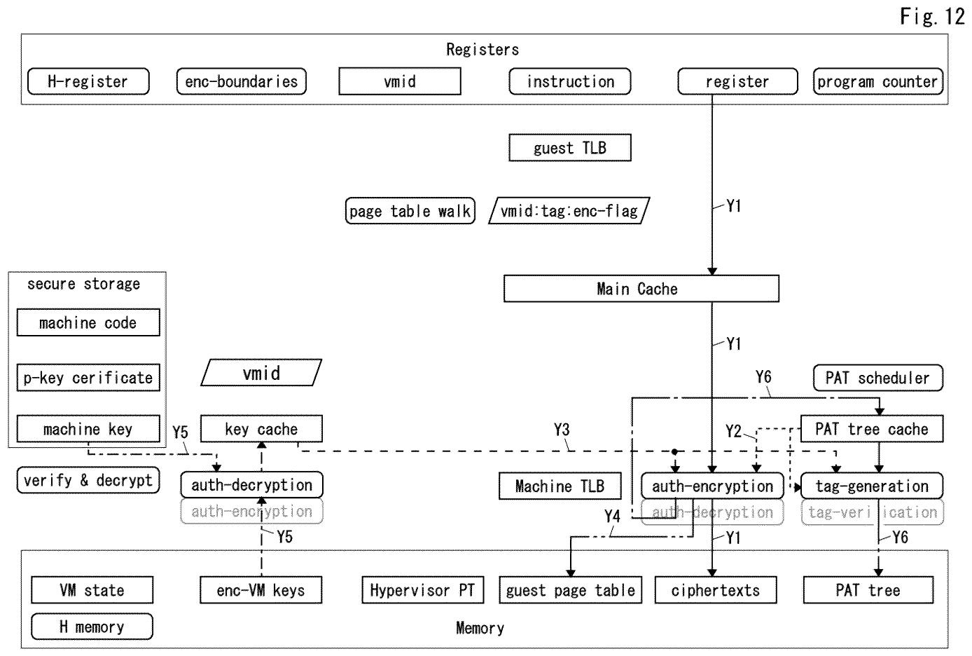

The lower part of FIG. 7 illustrates a flow of processing of translating the address of the cache of the guest into the address of the memory, a flow of address designation of the authentication tree, and a flow of key reading processing. FIG. 11 illustrates flows of data, keys, and the authentication tree at the time of data reading by the guest. FIG. 12 illustrates flows of data, keys, and the authentication tree at the time of data write-back by the guest.

### Address Translation and TLB

A virtual address of a guest is translated into a guest physical address using the guest page table managed by the guest. Then, for example, the cache is accessed by the guest physical address tagged with identification information vmid. Further, when data read from the cache is written back to the memory, the guest physical address is translated into a machine physical address, and the memory is accessed by the machine physical address.

The guest physical address is translated into the machine physical address using the hypervisor page table managed by the hypervisor. Then, for example, access to the cache is performed by the machine physical address (not tagged with identification information vmid). Further, when data read from the cache is written back to the memory, the memory is directly accessed using the machine physical address.

The MMU translates the virtual address of the guest into either the guest physical address or the machine physical address, and then searches a cache line to be accessed in the cache. Here, both of two types of the address translation depend on the guest page table and the hypervisor page table. The reason why the translation from the virtual address to the guest physical address depends not only on the guest page table but also on the hypervisor page table is that a storage area of the guest page table among storage areas of the memory depends on a storage area of the hypervisor page table. However, the reliability of the guest page table is guaranteed by authenticated encryption processing.

Translation contents (a correspondence table) of each of the above-described two types of address translation used during the access to the cache are cached in the TLB of the guest. For example, when the identification information vmid and the virtual address are input, the TLB of the guest outputs the guest physical address tagged with the identification information vmid according to the virtual address or the machine physical address not tagged with the identification information vmid according to the virtual address using the correspondence table related to the identification information vmid. When the guest physical address or the machine physical address associated to the virtual address does not exist in the correspondence table, the TLB of the guest outputs the guest physical address tagged with the identification information vmid according to the virtual address or the machine physical address not tagged with the identification information vmid according to the virtual address using the guest page table or the hypervisor page table.

In the case of access to the memory from the cache, the MMU also performs processing of translating the guest physical address into the machine physical address using the hypervisor page table. Translation contents (a correspondence table) of address translation used during the access to the memory from the cache are cached in the TLB of the machine. FIG. 7 also illustrates processing using the above-described two types of page tables.

### Basic Configuration of Authenticated Encryption Processing

A basic configuration of authenticated encryption processing will be described.

In the present example embodiment, it is assumed that the cache is of a write-back type, and data stored in the cache of each virtual machine is identified by a guest physical address of the virtual machine.

In the present example embodiment, a case where data is written from the register to the cache (a cache at the highest layer when there are a plurality of hierarchical caches) according to an instruction of the CPU and a case where data is written from the memory to the cache (a cache at the lowest layer when there are a plurality of hierarchical caches) according to an instruction of the MMU will be described as an example of writing data to the cache.

In the present example embodiment, a case where data is read from the cache to the register according to an instruction of the CPU, a case where an instruction is read from the cache to the CPU, and a case where data is read from the cache to the memory according to an instruction of the MMU will be described as examples of reading of data from the cache.

In the present example embodiment, it is assumed that all pieces of data to be written into the cache is plaintext. In addition, it is assumed that data is transferred between the plurality of hierarchical caches by a normal read operation and a normal write-back operation.

### Processing of Secure Processor and MMU in Authenticated Encryption Processing

Next, processing of a secure processor and an MMU in authenticated encryption processing will be described.

The information processing device 1 includes a seed for generating a pseudo random number and a master counter holding an internal state in order to enable the authenticated encryption processing. The information processing device 1 has a pair of a signature key S and a verification key V used for authentication, and a pair of a public key E and a private key D used for encryption. Here, a CPU manufacturer certifies and publishes the public key E and the verification key V. It is assumed that a secure communication channel is provided among a machine, the secure processor, and the MMU. It is assumed that not only the MMU but also the secure processor can safely access a key cache storing a key K of a virtual machine. It is assumed that the information processing device 1 has data related to various conditions of the machine on which the secure processor is mounted.

First, when identification information ID and a ciphertext C of the key K encrypted with the public key E are received from the machine, the secure processor decrypts the ciphertext C with the private key D to generate the key K, and then stores the identification information ID and the key K in the key cache.

Thereafter, when the identification information ID and an authenticator L of a counter R are received from the machine, the MMU reads the key K associated to the identification information ID from the key cache, verifies the authenticator L of the counter R using the key K, and stores the counter R in the key cache in addition to the identification information ID and the key K if there is no problem in the verification result.

Thereafter, when a sufficiently short message is received from the machine, the secure processor generates a signature for the message with the signature key S, and then returns the signature to the machine. Thereafter, when a request to generate a pseudo random number is received from the machine, the secure processor generates a pseudo random number using the master counter and the seed, and then returns the pseudo random number to the machine.

### BYOK Key Management in Authenticated Encryption Processing

Next, bring your own key (BYOK) key management in authenticated encryption processing will be described.

In the present example embodiment, a case where a key used for encryption is generated by a user himself/herself and used in a trusted execution environment (TEE) will be described as an example. Typically, when the key used for encryption is used without leaking to the outside of a CPU or a processor that is secure, confidentiality of the key can be greatly improved. However, for the purpose that the user of a virtual machine desires to hide contents of the virtual machine from the hypervisor, the fact that the user knows the key (that is, the key is leaked to the outside of the CPU or the like) itself is not a threat.

Hereinafter, a method of safely sharing a TEE guaranteed by a cloud and a CPU and a key, a method of loading and verifying an image (data) of a virtual machine encrypted using the shared key, a method of loading the same image to another TEE, and a method of performing migration to a TEE guaranteed by the cloud and the CPU and recognized by a user will be described.

### Preliminary Preparation

First, preliminary preparation is performed. It is assumed that a TEE has a pair of secure public key ET and private key DT. It is assumed that a TEE manufacturer has a pair of a signature key SC and a verification key VC and the verification key VC is publicly recognized. It is assumed that the TEE manufacturer discloses a signature σC_ET using the signature key SC for the public key ET for all manufactured TEEs. Various attributes are also added to a signature target. It is assumed that a cloud provider has a pair of a signature key SP and a verification key VP and the verification key VP is publicly recognized. It is assumed that a cloud provider P discloses a signature σP_ET using the signature key SP for the public key ET for all provided clouds. Various attributes are also added to a signature target. It is assumed that a user U has a pair of a signature key SU and a verification key VU. The verification key VU is recognized as a verification key of the user U by the cloud provider P.

### Key Installation

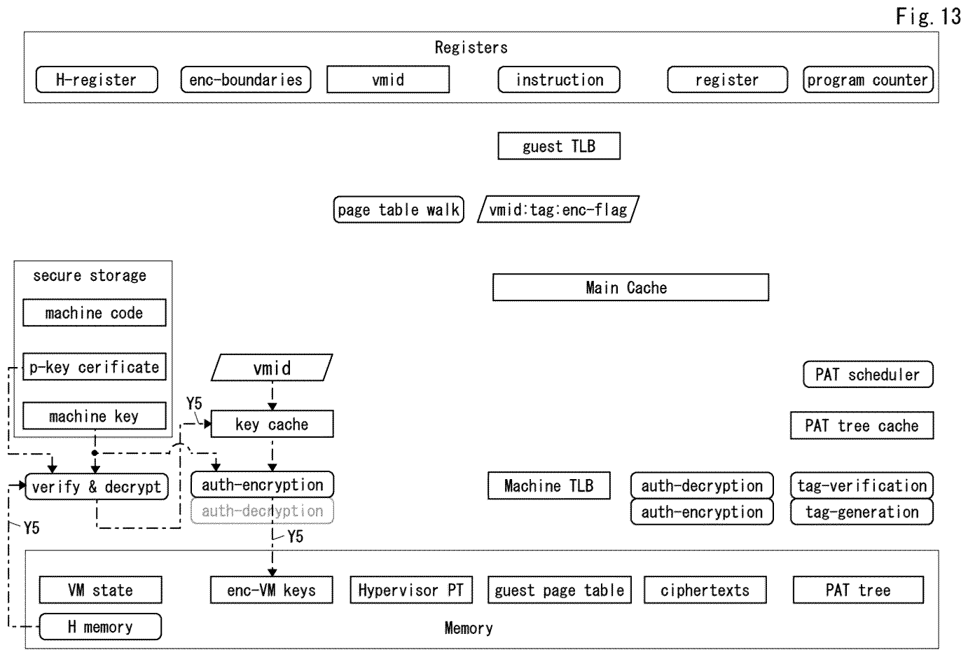

Thereafter, key installation is performed. FIG. 13 is a diagram illustrating flows of the key installation. As illustrated in FIG. 13, first, the user U generates a key KU, a root counter RU, and various conditions FU to be used for authenticated encryption processing. Thereafter, the user U registers the pair of signature key SP and verification key VP to the cloud provider P. Thereafter, the user U receives a list of the public keys ET having appropriate attributes from the cloud provider P, and verifies the signatures σC_ET and σP_ET using the verification keys VC and VP.

Thereafter, the user U encrypts the key KU and the various conditions FU with the public key ET to generate a ciphertext CU. The user U generates a signature σU_CU for the ciphertext CU using the signature key SU. Thereafter, the user U sends information regarding the user U, the ciphertext CU, and the signature σU_CU to the cloud provider P. The cloud provider P verifies the signature σU_CU using the verification key VU, and accepts the information regarding the user U and the ciphertext CU if there is no problem in the verification result. Thereafter, the cloud provider P passes the ciphertext CU to the hypervisor. The machine is assumed to include an interface through which the hypervisor passes the ciphertext CU to the machine. Thereafter, the hypervisor generates a locally unique key identifier IDU and passes the key identifier IDU and the ciphertext CU to the machine. Thereafter, the machine passes the key identifier IDU and the ciphertext CU to the secure processor. Thereafter, the secure processor decrypts the ciphertext CU to generate the key KU and the various conditions FU, then confirms whether the various conditions FU satisfy predetermined conditions, and stores the key KU indexed using the key identifier IDU in the key cache if the various conditions FU satisfy the predetermined conditions.

### Loading of Private Image

Thereafter, a private image is loaded. Specifically, first, the user U of a cloud prepares an image of a guest machine. The image of the guest machine includes an image DU of a storage, an image of a memory, an image of a register, and predetermined setting contents OU. In the guest machine prepared by the user U, private information or the like is set to allow this machine to safely communicate with the user. Then, in the guest machine prepared by the user U, the image of the storage is disposed as the storage as it is, and the image of the memory is disposed as the memory as it is. As a result, the guest machine can operate according to an instruction immediately after being prepared. Here, the storage is assumed to be a storage related to authenticated encryption processing. It is assumed that a key of the storage is included only in the image of the memory, or is encrypted by the authenticated encryption processing similarly to the case of a key of the memory.

Thereafter, in the authenticated encryption processing, the user U encrypts the image of the memory and the image of the register using the key KU and the root counter RU to generate a ciphertext MU. The user U generates an authenticator LU of the root counter RU. Signatures σU_MU, σU_DU, σU_OU, σU_RU, and σU_LU for the ciphertext MU, the image DU of the storage, the setting contents OU, the root counter RU, and the authenticator LU are generated using the signature key SU.

Thereafter, the user U sends U, MU, DU, OU, RU, LU, and the signatures σU_MU, σU_DU, σU_OU, σU_RU, and σU_LU to the cloud provider P. The cloud provider P verifies the signatures σU_MU, σU_DU, σU_OU, σU_RU, and σU_LU using the verification key VU, and accepts U, MU, DU, OU, RU, and LU if there is no problem in the verification result.

Thereafter, the cloud provider P passes MU, DU, OU, RU, and LU to the hypervisor. The hypervisor writes the ciphertext MU into the memory, disposes the image DU of the storage as it is in the storage, and performs setting according to the setting contents OU.

Thereafter, the hypervisor designates an address range of the key identifier IDU, the root counter RU, the authenticator LU, and the ciphertext MU, and requests the machine to hand authority over to the guest.

Thereafter, the machine passes the key identifier IDU, the root counter RU, and the authenticator LU to the MMU. The MMU verifies the authenticator LU of the root counter RU using the key KU, and stores the root counter RU in the key cache in addition to the key identifier IDU and the key KU if there is no problem in the verification result.

Thereafter, the machine designates the key identifier IDU to the MMU, restores the register of the guest from the register included in the ciphertext MU with the assistance of the MMU, and then, hands the execution authority over from the hypervisor to the guest. The MMU runs the guest using the key KU and the root counter RU.

Between the user U and a virtual machine, communication is safely performed by private information set in the virtual machine. Although attestation is not required in this process, it can also be said that authentication in the authenticated encryption processing corresponds to the attestation.

### Migration

Thereafter, migration is performed. In the present example embodiment, a case where a machine in which data in a memory is encrypted using a key K is migrated from a certain TEE to another TTE when the machine is operated in the certain TEE will be described.

First, the migration is set. It is assumed that the user U generates the key KU and various conditions FU′ to be used for authenticated encryption processing. It is assumed that the TEE before the migration has a pair of a public key ET′ and a private key DT', and a signature σC_ET′ and a signature σP_ET′ using the signature key SC for the public key ET′ are disclosed.

The user U receives a list of the public keys ET′ having appropriate attributes from the cloud provider P, and verifies the signature σC_ET′ and the signature σP_ET′ using the verification key VC and the verification key VP. Thereafter, the user U encrypts the key KU and the various conditions FU′ with the public key ET′ to generate a ciphertext CU′. The user U generates a signature σU_CU′ for the ciphertext CU′ using the signature key SU. Thereafter, the user U sends information regarding the user U, the ciphertext CU', and the signature σU_CU′ to the cloud provider P. The cloud provider P verifies the signature σU_CU′ using the verification key VU, and accepts the information regarding the user U and the ciphertext CU′ if there is no problem in the verification result.

Thereafter, the cloud provider P passes the ciphertext CU′ to the hypervisor. Thereafter, the hypervisor generates a locally unique key identifier IDU′ and passes the key identifier IDU′ and the ciphertext CU′ to the machine. Thereafter, the machine passes the key identifier IDU′ and the ciphertext CU′ to the secure processor. Thereafter, the secure processor decrypts the ciphertext CU′ to generate the key KU and the various conditions FU', then confirms whether the various conditions FU′ satisfy predetermined conditions, and stores the key KU indexed using the key identifier IDU′ in the key cache if the various conditions FU′ satisfy the predetermined conditions.

After the migration is set, the migration is performed. Specifically, the hypervisor first confirms that the key of the user U is installed in a TEE T′, and then determines to migrate a virtual machine M from a TEE T to the TEE T′. Thereafter, the hypervisor copies a storage and a memory of the virtual machine M formed in the machine to which the TEE T belongs to another machine to which the TEE T′ belongs. Each time the storage and memory of the virtual machine M are changed, the hypervisor copies the changed storage and memory of the virtual machine M to the another machine. Thereafter, the hypervisor stops the virtual machine M. The hypervisor also sends an authenticated ciphertext using the key KU of a register of the virtual machine M generated at this time to the TEE T′.

Thereafter, the hypervisor asks the MMU to generate an authenticator LU′ with the key KU of a current root counter RU′ in order to perform the migration. Thereafter, the hypervisor sends the root counter RU′ and the authenticator LU′ to a hypervisor of the machine to which the TEE T′ belongs.

Thereafter, the hypervisor of the TEE T′ designates the key identifier IDU′ associated to the key KU and passes the register of the virtual machine M, the root counter RU′, and the authenticator LU′ to the machine of the TEE T′. The machine of the TEE T′ passes the key identifier IDU′, the root counter RU′, and the authenticator LU′ to the MMU.

Thereafter, the MMU verifies the authenticator LU′ of the root counter RU′ using the key KU, and stores the root counter RU′ in the key cache in addition to the key identifier IDU′ and the key KU if there is no problem in the verification result.

Thereafter, the machine designates the key identifier IDU′ to the MMU, and then hands the execution authority over from the hypervisor to the guest. The MMU runs the guest using the key KU and the root counter RU′.

The hypervisor of the TEE T′ requests the hypervisor running on the TEE T to send what has not been acquired from the latest memory and storage of the virtual machine M in the machine of the TEE T. When all of the latest memory and storage of the virtual machine M in the machine of the TEE T have been acquired, the machine of the TEE T is deleted. Sequential acquisition of the memory in this migration is the same as normal migration. Since the same key KU can be used for the TEEs T and T′, the memory is duplicated directly in the encrypted state.

As described above, the information processing device according to the present example embodiment can prevent an attack on the cache from the hypervisor by configuring the cache to enable access to the data storage area designated by the guest physical address managed by the guest. That is, the information processing device according to the present example embodiment can improve confidentiality and safety against the attack on the virtual machine from the hypervisor.

The present disclosure can be achieved by causing a CPU to execute a computer program for part or all of processing of the information processing devices according to the present example embodiments.

The above-described program includes a command group (or software codes) for causing a computer to perform one or more functions that have been described in the example embodiments when the program is read by the computer. The program may be stored in a non-transitory computer-readable medium or in a tangible storage medium. As an example and not by way of limitation, a computer-readable medium or tangible storage medium includes a random-access memory (RAM), a read-only memory (ROM), a flash memory, a solid-state drive (SSD), or other memory technology, a CD-ROM, a digital versatile disc (DVD), a Blu-ray (registered trademark) disk, or other optical disk storages, a magnetic cassette, a magnetic tape, a magnetic disk storage, or other magnetic storage devices. The program may be transmitted on a transitory computer-readable medium or a communications medium. As an example and not by way of limitation, a transitory computer-readable or communication medium includes electrical, optical, acoustic, or other forms of propagated signals.

Although the example embodiments of the present disclosure have been described in detail with reference to the drawings, specific configurations are not limited to the above, and various design changes and the like can be made without departing from the gist of the present disclosure.

Some or all of the above-described example embodiments may be described as the following supplementary notes, but are not limited to the following supplementary notes.

### Supplementary Note 1

An information processing device including:
a memory having a data storage area to which a machine physical address is assigned;
a cache having a data storage area to which a guest physical address is assigned;
an authenticated encryption engine performing encryption processing and authentication processing on data to be transferred between the cache and the memory;
a first address translation means for translating an external address indicating access to data to be subjected to the encryption processing and the authentication processing into the guest physical address, the first address translation means being managed by a guest; and
a second address translation means for translating the guest physical address into a machine physical address associated to the guest physical address, the second address translation means being managed by a hypervisor.

### Supplementary Note 2

The information processing device according to Supplementary Note 1, wherein the cache further has a data storage area to which the machine physical address is assigned, in addition to the data storage area to which the guest physical address is assigned.

### Supplementary Note 3

The information processing device according to Supplementary Note 1, wherein
the cache further has a data storage area to which the machine physical address is assigned, in addition to the data storage area to which the guest physical address is assigned, and
the first address translation means further translates the external address indicating access to data not to be subjected to the encryption processing and the authentication processing into the machine physical address associated to the external address.

### Supplementary Note 4

The information processing device according to Supplementary Note 1, wherein the first address translation means translates the external address based on identification information of a virtual machine into the guest physical address, in addition to the external address.

### Supplementary Note 5

The information processing device according to Supplementary Note 4, wherein, during a context switch, a value of a register of the virtual machine is stored in a storage area designated by the guest physical address assigned to the virtual machine among storage areas of a cache of the virtual machine.

### Supplementary Note 6

The information processing device according to Supplementary Note 1, wherein the authenticated encryption engine performs, on the data to be transferred between the cache and the memory, the encryption processing and the authentication processing using an authentication tree including a plurality of nodes connected in a tree shape, each of the nodes being assigned with a pair of a counter and an identifier.

### Supplementary Note 7

A control method for an information processing device that includes: a memory having a data storage area to which a machine physical address is assigned; a cache having a data storage area to which a guest physical address is assigned; an authenticated encryption engine performing encryption processing and authentication processing on data to be transferred between the cache and the memory; a first address translation means managed by a guest; and a second address translation means managed by a hypervisor,
the control method including:
translating an external address indicating access to data to be subjected to the encryption processing and the authentication processing into a guest physical address using the first address translation means in a case of accessing the cache; and
translating the guest physical address into a machine physical address associated to the guest physical address using the second address translation means in a case of accessing the memory.

### Supplementary Note 8

The control method for the information processing device according to Supplementary Note 7, wherein the cache further includes a data storage area to which the machine physical address is assigned, in addition to the data storage area to which the guest physical address is assigned,
the control method further including translating the external address indicating access to data not to be subjected to the encryption processing and the authentication processing into the machine physical address associated to the external address using the first address translation means.

### Supplementary Note 9

A non-transitory computer-readable medium on which a control program is stored, the control program causing a computer to execute control processing in an information processing device that includes: a memory having a data storage area to which a machine physical address is assigned; a cache having a data storage area to which a guest physical address is assigned; an authenticated encryption engine performing encryption processing and authentication processing on data to be transferred between the cache and the memory; a first address translation means managed by a guest; and a second address translation means managed by a hypervisor,
the control program causing the computer to execute the control processing including:
processing of translating an external address indicating access to data to be subjected to the encryption processing and the authentication processing into a guest physical address using the first address translation means in a case of accessing the cache; and
processing of translating the guest physical address into a machine physical address associated to the guest physical address using the second address translation means in a case of accessing the memory.

### Supplementary Note 10

The non-transitory computer-readable medium on which the control program is stored according to Supplementary Note 9, wherein the cache further includes a data storage area to which the machine physical address is assigned, in addition to the data storage area to which the guest physical address is assigned,
the control program causing the computer to execute the control processing further including processing of translating the external address indicating access to data not to be subjected to the encryption processing and the authentication processing into the machine physical address associated to the external address using the first address translation means.

### REFERENCE SIGNS LIST

1 information processing device
101 cache
102 memory
103 authenticated encryption engine
104 first address translation unit
105 second address translation unit

What is claimed is:

1. An information processing device comprising:
a memory having a data storage area to which a machine physical address is assigned;
a cache having a data storage area to which a guest physical address is assigned;
an authenticated encryption engine performing encryption processing and authentication processing on data to be transferred between the cache and the memory;
a first address translation unit configured to translate an external address indicating access to data to be subjected to the encryption processing and the authentication processing into the guest physical address, the first address translation unit being managed by a guest; and
a second address translation unit configured to translate the guest physical address into a machine physical address associated to the guest physical address, the second address translation unit being managed by a hypervisor.

2. The information processing device according to claim 1, wherein the cache further has a data storage area to which the machine physical address is assigned, in addition to the data storage area to which the guest physical address is assigned.

3. The information processing device according to claim 1, wherein
the cache further has a data storage area to which the machine physical address is assigned, in addition to the data storage area to which the guest physical address is assigned, and
the first address translation unit is further configured to translate the external address indicating access to data not to be subjected to the encryption processing and the authentication processing into the machine physical address associated to the external address.

4. The information processing device according to claim 1, wherein the first address translation unit is configured to translate the external address based on identification information of a virtual machine into the guest physical address, in addition to the external address.

5. The information processing device according to claim 4, wherein, during a context switch, a value of a register of the virtual machine is stored in a storage area designated by the guest physical address assigned to the virtual machine among storage areas of a cache of the virtual machine.

6. The information processing device according to claim 1, wherein the authenticated encryption engine performs, on the data to be transferred between the cache and the memory, the encryption processing and the authentication processing using an authentication tree including a plurality of nodes connected in a tree shape, each of the nodes being assigned with a pair of a counter and an identifier.

7. A control method for an information processing device that includes: a memory having a data storage area to which a machine physical address is assigned; a cache having a data storage area to which a guest physical address is assigned; an authenticated encryption engine performing encryption processing and authentication processing on data to be transferred between the cache and the memory; a first address translation unit managed by a guest; and a second address translation unit managed by a hypervisor,
the control method comprising:
translating an external address indicating access to data to be subjected to the encryption processing and the authentication processing into a guest physical address using the first address translation unit in a case of accessing the cache; and
translating the guest physical address into a machine physical address associated to the guest physical address using the second address translation unit in a case of accessing the memory.

8. The control method for the information processing device according to claim 7, wherein the cache further includes a data storage area to which the machine physical address is assigned, in addition to the data storage area to which the guest physical address is assigned,
the control method further comprising translating the external address indicating access to data not to be subjected to the encryption processing and the authentication processing into the machine physical address associated to the external address using the first address translation unit.

9. A non-transitory computer-readable medium on which a control program is stored, the control program causing a computer to execute control processing in an information processing device that includes: a memory having a data storage area to which a machine physical address is assigned; a cache having a data storage area to which a guest physical address is assigned; an authenticated encryption engine performing encryption processing and authentication processing on data to be transferred between the cache and the memory; a first address translation unit managed by a guest; and a second address translation unit managed by a hypervisor,
the control program causing the computer to execute the control processing comprising:
processing of translating an external address indicating access to data to be subjected to the encryption processing and the authentication processing into a guest physical address using the first address translation unit in a case of accessing the cache; and
processing of translating the guest physical address into a machine physical address associated to the guest physical address using the second address translation unit in a case of accessing the memory.

10. The non-transitory computer-readable medium on which the control program is stored according to claim 9, wherein the cache further includes a data storage area to which the machine physical address is assigned, in addition to the data storage area to which the guest physical address is assigned,
the control program causing the computer to execute the control processing further comprising processing of translating the external address indicating access to data not to be subjected to the encryption processing and the authentication processing into the machine physical address associated to the external address using the first address translation unit.
